(19) United States
(12) Patent Application Publication
(10) Pub. No.: US 2026/0280183 A1
(43) Pub. Date: Sep. 17, 2026

(54) POWER ADAPTER

(71) Applicant: TAIWAN LINE TEK ELECTRONIC CO., LTD., New Taipei City (TW)

(72) Inventor: Long-Shcei CHEN, New Taipei City (TW)

(21) Appl. No.: 19/093,109

(22) Filed: Mar. 27, 2025

(30) Foreign Application Priority Data
Mar. 11, 2025 (TW) 114202425

(51) Int. Cl. H01R 13/52; H01R 13/625; H01R 24/38; H01R 107/00

(52) U.S. Cl. CPC H01R 13/5219; H01R 13/625; H01R 24/38; H01R 2107/00; H01R 2201/26

(57) ABSTRACT

A power adapter having a female connector and a male connector, where during a mating process, an axial mating operation is firstly performed to drive engaging bumps of the female connector to slide in guiding grooves of the male connector to make the power terminals and the signal terminals on each side of the female connector and the male connector connected with each other; and then, a rotating operation is performed to make the engaging bumps slide into retaining grooves of the male connector so that the female connector and the male connector are tightly connected and fastened to each other.

### BACKGROUND OF THE INVENTION

### Field of the Invention

The invention is related to a power adapter, especially to a dustproof and splash-proof power adapter.

### Description of the Related Art

With the global warming getting worse, governments around the world have been encouraging electric vehicles, making electric vehicles more and more common, and governments are also installing charging piles (or charging stations) at locations beside highways or in freeway rest stops for charging electric vehicles.

However, charging piles (or charging stations) are still not as common as gas stations, and the time it takes to fill up the battery is much longer than the time it takes to fill up the gas tank, which makes the owners of electric vehicles often feel anxious that the battery is about to run out of power but they cannot get the charging service right away. To solve this problem, portable chargers have been proposed in the market. Electric-vehicle owners can charge their electric vehicle by simply plugging an AC plug of the portable charger into a mains outlet and inserting a charging nozzle of the portable charger into a charging port of the electric vehicle.

However, as there are stringent safety requirements for charging electric vehicles, whether it is a charging pile (or charging station) or a portable charger, the charging wiring must be dustproof and splash-proof to avoid fire events during the charging process.

To solve the aforementioned problems, there is a need for a dust-proof and splash-proof power adapter in the field.

### SUMMARY OF THE INVENTION

The main objective of the invention is to provide a power adapter, which can make a female connector and a male connector thereof tightly connected and fastened to each other by a number of engaging structures evenly disposed about a virtual axial line, so as to provide a dustproof and splash-proof function.

Another objective of the invention is to provide a power adapter that can be easily assembled by virtue of a simple nesting structure, thereby improving the production efficiency.

To achieve the above objectives, a power adapter is proposed, which has:

a female connector having a first housing, a rotatable ring disposed around the first housing, and a plurality of first power terminals and a plurality of first signal terminals secured in the first housing, the first power terminals and the first signal terminals being used to connect to an alternating current (AC) power source via a first cable, and an inner surface of the rotatable ring having n bumps evenly disposed about a virtual axial line of the rotatable ring, n being an integer greater than 1; and

a male connector having a second housing and a plurality of second power terminals and a plurality of second signal terminals secured in the second housing for connecting to a control module via a second cable, and an outer surface of the second housing having n groove structures evenly disposed about a virtual axial line of the second housing, each of the groove structures having a guiding groove and a retaining groove connected to the guiding groove;

during a process of mating the female connector to the male connector, an axial mating operation being firstly performed to drive the bumps to slide in the guiding grooves correspondingly, which in turn makes the first power terminals and the first signal terminals connected with the second power terminals and the second signal terminals correspondingly; and then, a rotating operation is performed to make the bumps slide into the retaining grooves correspondingly so that the female connector and the male connector are tightly connected and fastened to each other.

In one embodiment, the first housing is fitted with a waterproof gasket.

In one embodiment, the first housing has a first bracket to secure the first power terminals and the first signal terminals.

In one embodiment, the second housing has a second bracket to secure the second power terminals and the second signal terminals.

In one embodiment, the control module is a charging gun.

In one embodiment, n is equal to 3.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 is a schematic diagram of one embodiment of the power adapter of the invention;

FIG. 2 is an exploded view of the power adapter of FIG. 1;

FIG. 3 is another exploded view of the power adapter of FIG. 1;

FIG. 4 illustrates a first connecting phase of the power adapter of FIG. 1 resulting from an axial mating operation, in which the power terminals and the signal terminals on each side of the female connector and the male connector are pulled close to connect with each other; and

FIG. 5 illustrates a second connecting phase of the power adapter of FIG. 1 resulting from a rotating operation, in which the female connector and the male connector are tightly fastened to each other due to the rotating operation.

### DETAILED DESCRIPTION OF THE PREFERRED EMBODIMENTS

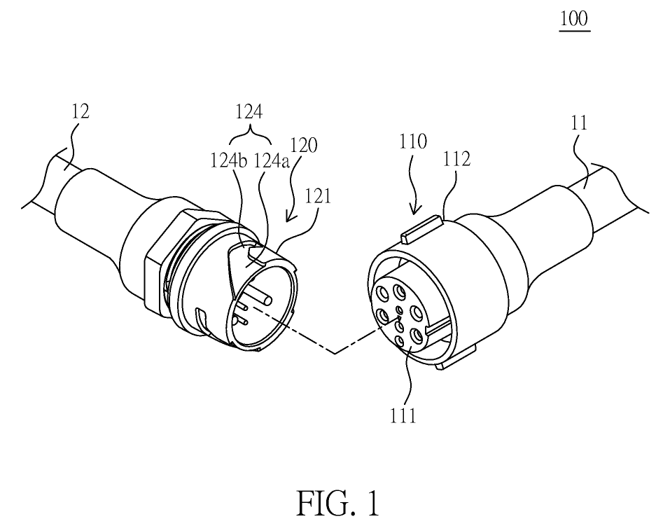

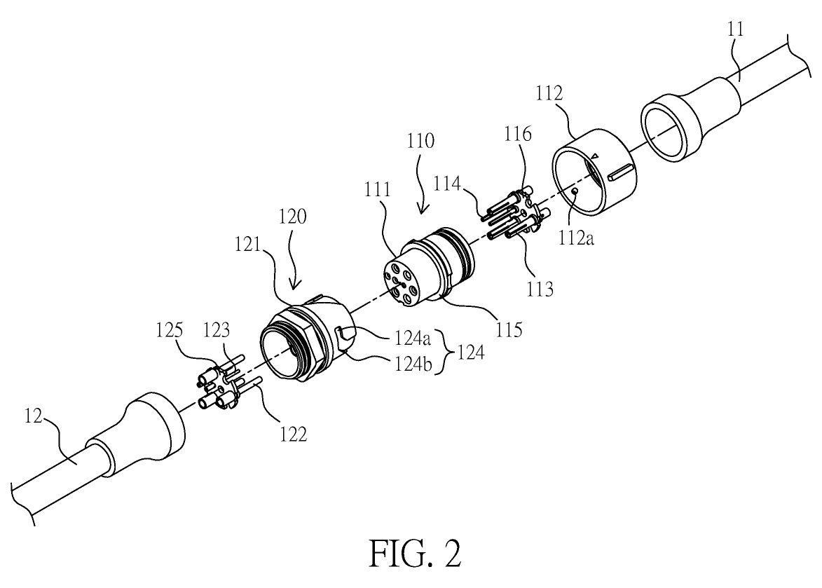

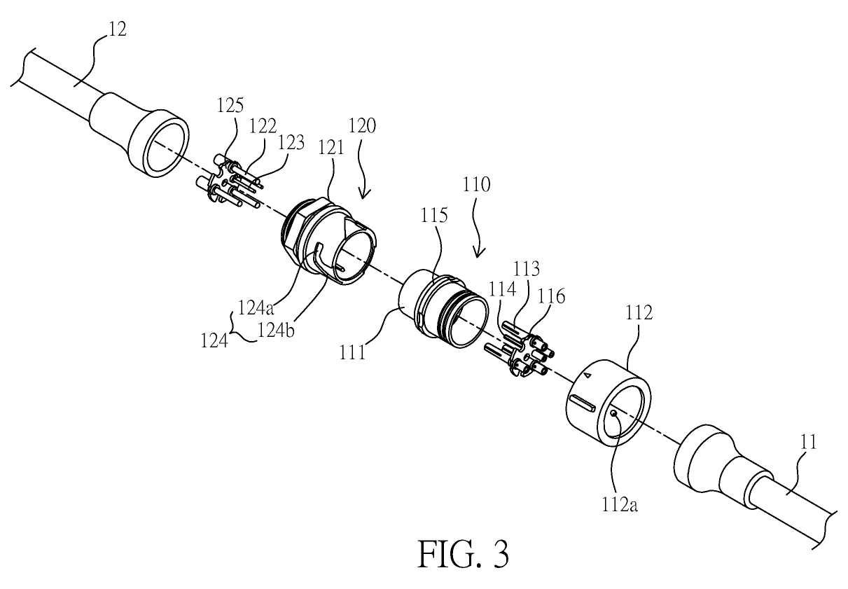

Please refer to FIGS. 1-3, in which FIG. 1 is a schematic diagram of one embodiment of the power adapter of the invention; FIG. 2 is an exploded view of the power adapter of FIG. 1; and FIG. 3 is another exploded view of the power adapter of FIG. 1. As shown in FIGS. 1-3, a power adapter 100 includes a female connector 110 and a male connector 120.

The female connector 110 has a first housing 111, a rotatable ring 112 disposed around the first housing 111, and a plurality of first power terminals 113 and a plurality of first signal terminals 114 secured in the first housing 111, the first power terminals 113 and the first signal terminals 114 being used to connect to an alternating current (AC) power source via a first cable 11, and an inner surface of the rotatable ring 112 having n bumps 112a evenly disposed about a virtual axial line of the rotatable ring 112, n being an integer greater than 1, preferably equal to 3.

The male connector 120 has a second housing 121, a plurality of second power terminals 122 and a plurality of second signal terminals 123, the second power terminals 122 and the second signal terminals 123 being secured in the second housing 121 and used for connecting to a control module, which can be a charging gun, via a second cable 12. In addition, an outer surface of the second housing 121 has n groove structures 124 evenly disposed about a virtual axial line of the second housing 121, each of the groove structures 124 having a guiding groove 124a and a retaining groove 124b connected to the guiding groove 124a, and the guiding groove 124a being preferably of a curved shape.

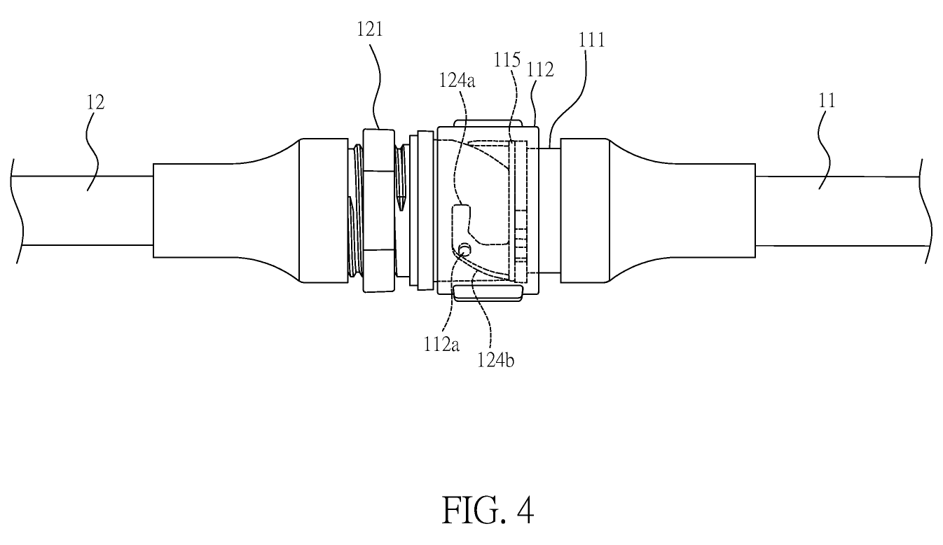

During a mating process of the female connector 110 and the male connector 120, an axial mating operation is firstly performed to attain a first connecting phase of the female connector 110 and the male connector 120, in which the bumps 112a are driven to slide in the guiding grooves 124a correspondingly, which in turn makes the first power terminals 113 and the first signal terminals 114 connected with the second power terminals 122 and the second signal terminals 123 correspondingly. The first connecting phase of the female connector 110 and the male connector 120 is illustrated in FIG. 4.

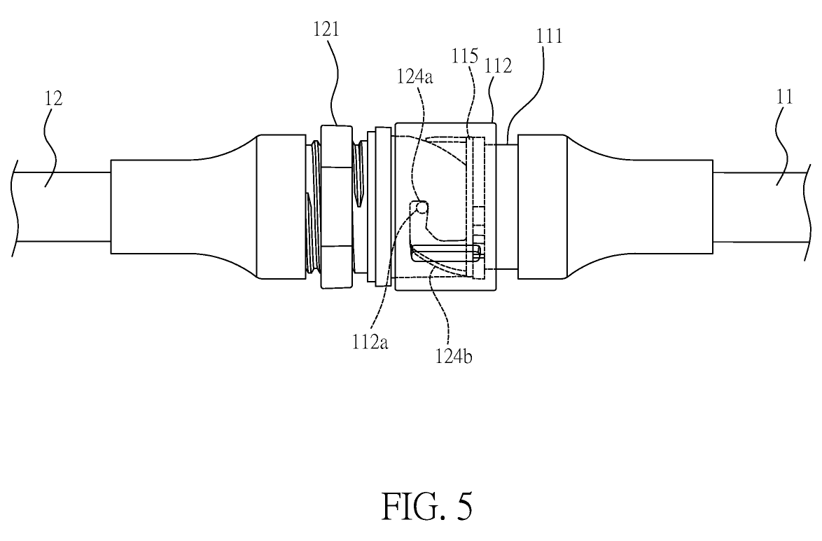

Next, performing a rotational operation on the female connector 110 and the male connector 120 to result in a second connecting phase of the female connector 110 and the male connector 120 as illustrated in FIG. 5, in which the bumps 112a are driven to slide into and retained in the retaining grooves 124b correspondingly to make the female connector 110 and the male connector 120 tightly fastened to each other.

In addition, the first housing 111 can be fitted with a waterproof gasket 115 to further provide a waterproof effect when the female connector 110 and the male connector 120 are tightly fastened to each other.

In addition, the first housing 111 can have a first bracket 116 to secure the first power terminals 113 and the first signal terminals 114.

In addition, the second housing 121 can have a second bracket 125 to secure the second power terminals 122 and the second signal terminals 123.

With the designs disclosed above, the invention offers the advantages as follows:

1. The power adapter of the invention can make a female connector and a male connector thereof tightly connected and fastened to each other by a number of engaging structures evenly disposed about a virtual axial line, so as to provide a dustproof and splash-proof function; and

2. The power adapter of the invention can be easily assembled by virtue of a simple nesting structure, thereby improving the production efficiency.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power adapter comprising:
a female connector having a first housing, a rotatable ring disposed around the first housing, and a plurality of first power terminals and a plurality of first signal terminals secured in the first housing, the first power terminals and the first signal terminals being used to connect to an alternating current power source via a first cable, and an inner surface of the rotatable ring having n bumps evenly disposed about a virtual axial line of the rotatable ring, n being an integer greater than 1; and
a male connector having a second housing and a plurality of second power terminals and a plurality of second signal terminals secured in the second housing for connecting to a control module via a second cable, and an outer surface of the second housing having n groove structures evenly disposed about a virtual axial line of the second housing, each of the groove structures having a guiding groove and a retaining groove connected to the guiding groove;
wherein, during a process of mating the female connector to the male connector, an axial mating operation being firstly performed to drive the bumps to slide in the guiding grooves correspondingly, which in turn makes the first power terminals and the first signal terminals connected with the second power terminals and the second signal terminals correspondingly; and then, a rotating operation is performed to make the bumps slide into the retaining grooves correspondingly so that the female connector and the male connector are tightly connected and fastened to each other.

2. The power adapter as disclosed in claim 1, wherein the first housing is fitted with a waterproof gasket.

3. The power adapter as disclosed in claim 1, wherein the first housing has a first bracket to secure the first power terminals and the first signal terminals.

4. The power adapter as disclosed in claim 1, wherein the second housing has a second bracket to secure the second power terminals and the second signal terminals.

5. The power adapter as disclosed in claim 1, wherein the control module is a charging gun.

6. The power adapter as disclosed in claim 1, where n is equal to 3.
